(19) United States
(12) Patent Application Publication
(10) Pub. No.: US 2006/0279217 A1
(43) Pub. Date: Dec. 14, 2006

(54) Light device including an outside bulb, especially a high pressure discharge lamp

(76) Inventors: Ulrich Peuchert, Bodenheim (DE); Thilo Zachau, Burstadt (DE); Franz Ott, Konnersreuth (DE); Peter Brix, Mainz (DE); Joerg Fechner, Mainz (DE)

Correspondence Address: TAYLOR & AUST, P.C., 142 SOUTH MAIN STREET, P. O. BOX 560, AVILLA, IN, 46710, US

(21) Appl. No.: 11/345,167

(22) Filed: Feb. 1, 2006

(30) Foreign Application Priority Data
Jun. 9, 2005 (DE) 10-2005-026 695.9

(51) Int. Cl. H01J 61/30; H01J 17/16; H01J 17/20

(52) U.S. Cl. 313/634; 313/623; 313/493; 313/573

(57) ABSTRACT

A light device, preferably a metal halide high pressure discharge lamp, which includes a first body which has a light element, a second body which encompasses the first body, whereby the second body consists essentially of an Al-silicate glass, for example a hard glass. The Al-silica glass has a Tg of >600° C., preferred >650° C., especially preferred >700° C., particularly preferred >750° C., and a thermal expansion coefficient α_{20/300}>0, preferably in the range of 3≦α_{20/300}≦6, particularly preferred 3.5≦α_{20/300}≦5.5

### BACKGROUND OF THE INVENTION

1. Field of the Invention

The present invention relates to a light device including at least one first body that includes a light element and a second body that encompasses the first body, and, more particularly, to high pressure discharge lamps and in particular to compact metal halide high pressure discharge lamps.

2. Description of the Related Art

In high pressure discharge lamps a first body forms a sealed discharge chamber which is filled with a charge which can be ionized. The discharge chamber is also referred to as burner. The discharge chamber of high pressure discharge lamps as described for example in WO 2004/077490 or WO2005/033802 and includes one or several metal halides, mercury and rare-earth halides. These are put into the burner at room temperature (RT) in liquid or in solid form and following the ignition are then present in gaseous form due to the prevailing high pressures and temperatures.

The second body which encompasses the first body and whose preferred form is that of a bulb serves the thermal encapsulation of the first body which represents the actual light emitting unit. It also serves as breakage/explosion protection or the protection of materials and to protect the lamp user from harmful rays, particularly UV rays.

The burners of high pressure discharge lamps, manufactured from silica glass or translucent ceramics (i.e. Al₂O₃, YAG ceramics) are operated at the highest possible operating temperature of up to 1000° C. or higher. The higher the operating temperatures are, the higher will be the color reproduction index and efficiency, at the same time decreasing the differences in light quality between individual lamps.

The space between the first and the second body is mostly or essentially evacuated for the purpose of thermal insulation. The second body which is also referred to as an enveloping bulb is doped with UV-blocking components for the purpose of UV-blocking.

The temperature on the second body, that is on the outside bulb of a high pressure discharge lamp or a so-called HID-lamp is 300° C.-850° C. This temperature is dependent upon a number of factors, one of which is the distance of the hot-spot of the burner from the bulb. Accordingly, the leadthrough area is clearly cooler than the bulb volume directly adjacent to the burner. Depending upon the power output of the burner and with very small distances of the hot-spot from the bulb's inside wall, wall temperatures of up to 800° C. or higher can prevail.

As previously described, the outside bulb can preferably distinguish itself through high UV blocking capabilities. Particularly the radiation type UV-C (around 260 nm) as well as the radiation type UV-B (around 310 nm) can be blocked by the bulb. Ideally, the UV-A radiation, around 360 nm, can also be blocked to as high an extent as possible. The areas between these more or less discrete Hg-UV lines can be blocked as efficiently as possible since mercury which is under pressure, or metal halides display wide emission bands in this area.

Translucent aluminum oxide which is capable of withstanding temperatures of up to 1100° C. or above is a material used besides silica glass for the first body, that is the so-called discharge chamber of high pressure discharge lamps.

The materials that are currently used for the second body, that is the outside bulb, are predominantly silica glass or multi-component glasses. An HID-lamp is described in WO 2004/077490 whereby the material cited for the outside bulb is quartz glass, hard glass or soft glass. However, the hard glass is not specified in further detail in WO 2004/077490.

With respect to materials, the utilization of silica glass as the material for the outside bulb has the disadvantage of an insufficient UV-blocking action. UV-blocking can be achieved in silica glass by doping of CeO₂, preferably at a content of <1 weight %. This however has the disadvantage of a residual transmission in the range of the hard UV-C radiation.

The utilization of soft glass in this context can lead to a restricted freedom in design and/or limitation of the power output of the lamp.

An additional problem of HID lamps in accordance with the current state of the art is the area of the leadthroughs. If, as described above, the first (inside) and/or second (outside) lamp bulb includes silica glass, then the leadthroughs, when viewed from the outside toward the inside, are manufactured from W- or Mo-wire which is welded to a Mo-foil having a thickness of <100 μm, as well as a second weld point to a W-wire or Nb-wire which leads into the interior of the lamp, for example W-discharge electrodes.

The utilization of a Mo-foil that has a thickness of <100 μm is necessary according to the state of the art, in order to keep tensions in the area of the glass-/metal leadthroughs as low as possible. The actual hermetic seal occurs here over only a few mm² contact surface of Mo-foil with the surrounding glass and is therefore very unreliable. In addition, limits are imposed upon the maximum current flow (approx. 20-25 Amp.) by this sealing technique.

Utilization of a Mo-foil also has the additional disadvantages, as described below. The Mo-foil has a tendency to burn during sealing of the leadthrough. In the current state of the art therefore, the sealing process is conducted in an inert gas flow, especially argon. During operation the fused in foils tend to oxidize. This may result in leakages and failure of the lamp. The thin foil permits only an insufficient energy transport into the lamp. The production, or more precisely the multiple welding together of metal components is time consuming and expensive. In addition, the dimensional expansion of the leadthrough system results in the overall length of the lamp becoming unfavorably large.

In order to overcome these disadvantages and to increase the compact design and/or design freedom of lights with HID-lamps as a light source, joining of the outside bulb with a base plate containing the leadthrough wires via a frit ring instead of fusing the outside bulb with a leadthrough wire is described in WO 2004/077490. The >10 mm long fusing zone that is thereby reduced to a minimum, predetermined by the thickness of the plate. According to WO 2004/077490 the basis plate may include glass, ceramics or glass-ceramics. As previously described “quartz glass, soft glass or hard glass” are cited for the bulb. The frit ring material is not further specified. As mentioned previously, a disadvantage in WO 2004/077490 is that the material of the outside bulb is not specified.

What is needed in the art is to overcome the disadvantages of the current state of the art relating to high pressure discharge lamps.

### SUMMARY OF THE INVENTION

The present invention provides a light device including a first inside body and a second outside body, whereby the second body (outside bulb) is joined preferably to a non-zero-expanding basis plate via a frit. This denotes that there is no contact of the bulb with the leadthrough wires. The material of the outer bulb has a high temperature tolerance, as well as zero thermal expansion. Specifically, only insignificant tensions arise and the aforementioned disadvantages are avoided in the area of the leadthorugh.

The invention comprises, in one form thereof, a light device, preferably a metal halide high pressure discharge lamp, comprising: a first body which includes a light element, a second body which encompasses the first body, whereby the second body consists essentially of an Al-silicate glass, for example a hard glass. The Al-silica glass has a Tg (transformation temperature (ISO 7884-8)) of >600° C., preferred 650° C., especially preferred 700° C., ideally >750° C., entirely preferred >770° C., particularly preferred >790° C., and a thermal expansion coefficient α_{20/300}>0, preferably in the range of 3≦α_{20/300}≦6, particularly preferred 3.5≦α_{20/300}≦5.5.

An aluminosilicate glass of the second body that is the material of the outside bulb can be a hard glass. The aluminosilicate glass composition advantageously provides an almost 100% blockage in the UV-C range. This denotes that all wavelengths around 260 nm, preferably up to and including 300 nm are not permitted to penetrate the bulb having a 1 mm thickness or more, at RT as well as operating temperatures. It is especially preferred if all wavelengths around the UV-B line (at 310 nm) are blocked (100%) during operation and especially preferred even wavelengths to 320 nm. The UV-C range is understood to be UV radiation around 260 nm. UV-B radiation is understood to be that around 310 nm and UV-A radiation as having wavelengths of around 365 nm.

In the inventive light device the lamp includes a plate containing a current feedthrough and a bulb. In order to avoid tensions between the outside bulb and the base plate, as well as in the area of the leadthrough wires, the expansion coefficient α_{20/300} of the base plate as well as of the outside bulb is preferably essentially the same to that of the metal of the feedthrough wires.

Therefore, the preferred material for the feedthrough wires is one of the following metals or alloys: Wolfram/Tungsten, Molybdenum, Niobium metal, Kovar alloy and Molezdenwanov alloy.

According to the thermal expansion coefficient α_{20/300} of these metals the expansion coefficient of the base plate as well as the outside bulb is therefore preferably in the inventive range of 3.5≦α_{20/300}≦5.5. For this reason the utilization of quartz glass is generally not possible. Therefore, for sufficient UV-C blocking a multi-component glass is particularly suitable, that is an aluminosilicate glass, hereinafter also referred to as “Al-silicate glass”.

In an especially preferred first embodiment the Al-silicate glass includes the following composition (weight % on oxide basis):

| | |
|---|---|
| SiO₂ | 50-66 |
| B₂O₃ | 0-5.5 |
| Al₂O₃ | 10-25 |
| MgO | 0-7 |
| CaO | 0-14 |
| SrO | 0-8 |
| BaO | 0-18 |
| P₂O₅ | 0-2 |
| ZrO₂ | 0-3 |
| TiO₂ | 0-5 |
| CeO₂ | 0-5 |
| MoO₃ | 0-5 |
| Fe₂O₃ | 0-5 |
| WO₃ | 0-5 |
| Bi₂O₃ | 0-5 |

Another preferred Al-silicate glass includes the following components (weight %):

| | |
|---|---|
| SiO₂ | 50-66 |
| B₂O₃ | 0-5.5 |
| Al₂O₃ | 13-25 |
| MgO | 0-7 |
| CaO | 5-14 |
| SrO | 0-8 |
| BaO | 6-18 |
| P₂O₅ | 0-2 |
| ZrO₂ | 0-3 |
| TiO₂ | 0-5 |
| CeO₂ | 0-5 |
| MoO₃ | 0-5 |
| Fe₂O₃ | 0-5 |
| WO₃ | 0-5 |
| Bi₂O₃ | 0-5 |

An additional Al-silicate glass of the invention includes the following components (weight %):

| | |
|---|---|
| SiO₂ | 50-66 |
| B₂O₃ | 0-<0.5 |
| Al₂O₃ | 14-25 |
| MgO | 0-7 |
| CaO | 5-14 |
| SrO | 0-8 |
| BaO | 6-18 |
| P₂O₅ | 0-2 |
| ZrO₂ | 0-3 |

Another inventive Al-silicate glass including the following components is also preferred (weight %):

| | |
|---|---|
| SiO₂ | 58-62 |
| B₂O₃ | 0-5.5 |
| Al₂O₃ | 13.5-17.5 |
| MgO | 0-7 |
| CaO | 5.5-14 |
| SrO | 0-8 |
| BaO | 6-10 |
| ZrO₂ | 0-2 |

The aforementioned Al-silicate glasses are essentially alkali-free. However, alkaliferous Al-silicate glasses may also be utilized in equally suitable form. These are based for example on the following glass compositions in weight %:

| | |
|---|---|
| SiO₂ | 50-70 |
| Al₂O₃ | 17-27 |
| Li₂O | >0-5 |
| Na₂O | 0-5 |
| K₂O | 0-5 |
| MgO | 0-5 |
| ZnO | 0-5 |
| TiO₂ | 0-5 |
| ZrO₂ | 0-5 |
| Ta₂O₅ | 0-8 |
| BaO | 0-5 |
| SrO | 0-5 |
| P₂O₅ | 0-10 |
| Fe₂O₃ | 0-5 |
| CeO₂ | 0-5 |
| BiO₃ | 0-3 |
| WO₃ | 0-3 |
| MoO₃ | 0-3 |

as well as customary refining agents, for example SnO₂, CeO₂, SO₄, Cl, As₂O₃ Sb₂O₃ in amounts of 0-4 weight %.

An additional suitable alkali-free glass is based on the following glass composition in weight %:

| SiO₂ | 35-70, particularly 35-60 |
|---|---|
| Al₂O₃ | 14-40, particularly 16.5-40 |
| MgO | 0-20, preferably 4-20, particularly 6-20 |
| ZnO | 0-15, preferably 0-9, particularly 0-4 |
| TiO₂ | 0-10, preferably 1-10 |
| ZrO₂ | 0-10, preferably 1-10 |
| Ta₂O₅ | 0-8, preferably 0-2 |
| BaO | 0-10, preferably 0-8 |
| CaO | 0-<8, preferably 0-5, particularly <0.1 |
| SrO | 0-5, preferably 0-4 |
| B₂O₃ | 0-10, preferably >4-10 |
| P₂O₅ | 0-10, preferably <4 |
| Fe₂O₃ | 0-5 |
| CeO₂ | 0-5 |
| Bi₂O₃ | 0-3 |
| WO₃ | 0-3 |
| MoO₃ | 0-3 |

as well as customary refining agents, for example SnO₂, CeO₂, SO4, Cl, As₂O₃ Sb₂O₃ in amounts of 0-4 weight %.

The inventive glass compositions distinguish themselves particularly in that a targeted adjustment of the UV edge is possible due to the addition of suitable UV-blockers. This also provides the possibility of a targeted adjustment of the transmission in the wavelength range of around 400 nm so that the blue cast which may occur in the emission of HID-lamps according to the current state of the art is reduced.

With the inventive Al-silicate glasses, particularly hard glasses it is possible to adjust the UV edge similar to that of UV-silica glass in the first instance through the addition of oxides, such as Fe₂O₃ or TiO₂ or also other classic UV blockers, such as Mo-, Nb and/or Ce-oxide. Accordingly, the inventive Al-silicate glass contains preferably at least one metal oxide, selected from the group consisting essentially of TiO₂, CeO₂, Fe₂O₃, WoO₃, ZrO₂, MoO₃, Bi₂O₃, Nb₂O₅ and/or Ta₂O₅.

Therefore, targeted influence over the quality of the white light can advantageously be exercised, when required. Provided the emission spectrum of the discharge body displays too much blue content, a targeted yellow self-coloring adjustment is also possible through the steepness of the UV-edge. This filters out excessive blue content. The yellow self-coloring compensates for the blue cast of the burner of the HID-lamp and in contrast to conventional HID-lamps an improved white impression is achieved.

The effect becomes all the more advantageous when temperature effects are considered additionally. Temperatures of between 600° C. and 850° C. or higher can occur on the inside wall of an HID-lamp that is close to the burner, causing the UV edge to be displaced toward lower energies.

According to an advantageous embodiment of the present invention, the Al-silicate glass is able to block the light wavelengths of less than/equal to 290 nm essentially completely in the range from RT to 700° C. Within the scope of the present invention “blocking essentially completely” denotes that the transmission factor is <0.01. An Al-silicate glass which essentially completely blocks light wavelengths of lesser than/equal to 300 nm, preferably smaller than/equal to 310 nm at temperatures of around 600° C., denoting that the transmission factor is <0.01, is even more advantageous. Especially at approximately 400 nm the Al-silicate glass can have a transmission factor in the range of 0.5-0.91.

According to an additional inventive design form the Al-silicate glass is selected so that at approximately 400 nm at 600° C. said glass has a transmission factor lower than 86%, and a Fe₂O₃ content >10 ppm, preferably >100 ppm, particularly >300 ppm.

The UV-edge can be adjusted as desired through elements of a suitable variation of parts of UV-blocking components and under consideration of the temperature shift. Thereby suitable transmissions can be generated at 400 nm which, depending on value will positively influence the reproduction index CRI and/or the color temperature in a lamp.

The reproduction index in a lamp is the so-called Color Rendering Index (CRI) The Color Rendering Index (CRI) describes the white impression of an illuminated surface. Depending on how many parts are missing from an optimum emission spectrum which distinguishes itself through an equally high intensity for wavelengths between 380 and 780 nm, or depending on how inhomogeneous the spectrum is, the white becomes objectively worse. The surface appears then more or less gray. A CRI index of 100 describes a lamp having an optimum emission spectrum, in other words, having an optimum white impression.

As described above, the light from high pressure discharge lamps (HID-lamps) may still have a blue cast, despite the most favorable optimization of the fillers in accordance with the current state of the art. At present lamps having a CRI of normally less than 90 are being sold. In utilizing the inventive glasses the blue cast can be reduced or completely compensated for through suitable doping at a concurrently high temperature stability, a thermal expansion α_{20/300}>0 and sufficient UV blocking, so that HID lamps with an CRI index >90, preferably >95 are achieved.

The present invention also provides the utilization of an Al-silicate glass for a light device, especially a metal halide high pressure discharge lamp as has already been described, whereby the Al-silicate glass possesses one of the aforementioned compositions.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1a is a perspective view of an embodiment of an HID-lamp with a second body which forms the outer bulb of the HID lamp according to the present invention;

FIG. 1b is a cross-sectional view of another embodiment of an HID-lamp with a second body which forms the outer bulb of the HID lamp according to the present invention;

FIG. 2 is transmission curves for the design examples A1, A2, A3 (doped alkali-free Al-silicate glasses), as well as comparison examples V1 (Ce-doped silica glass) and V2 (non-doped Al-silicate glass) at room temperature according to the present invention;

FIG. 3 is transmission curves for the design examples A1, A2, A3 and comparison examples V1 and V2 at 600° C. according to the present invention;

FIG. 4 is transmission curves for the design examples A4 and A5 (doped alkaliferous Al-silicate glasses), as well as comparison example V1 (Ce-doped silica glass), at room temperature and 600° C. according to the present invention;

FIGS. 5a and 5b are transmission data of glass A2 from FIG. 1 and FIG. 2, compared to the data of a glass having the same basic composition A2b at RT (5a) and 600° C. (5b), whereby the differences are in the Fe₂O₃ content (A2: 330 ppm, A2b: 10 ppm Fe); and

FIG. 6 is the position of the color of a lamp in the CIELab color diagram when utilizing bulb a) of the comparison example V1, as well as b) of the design example A2, each at 600° C.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

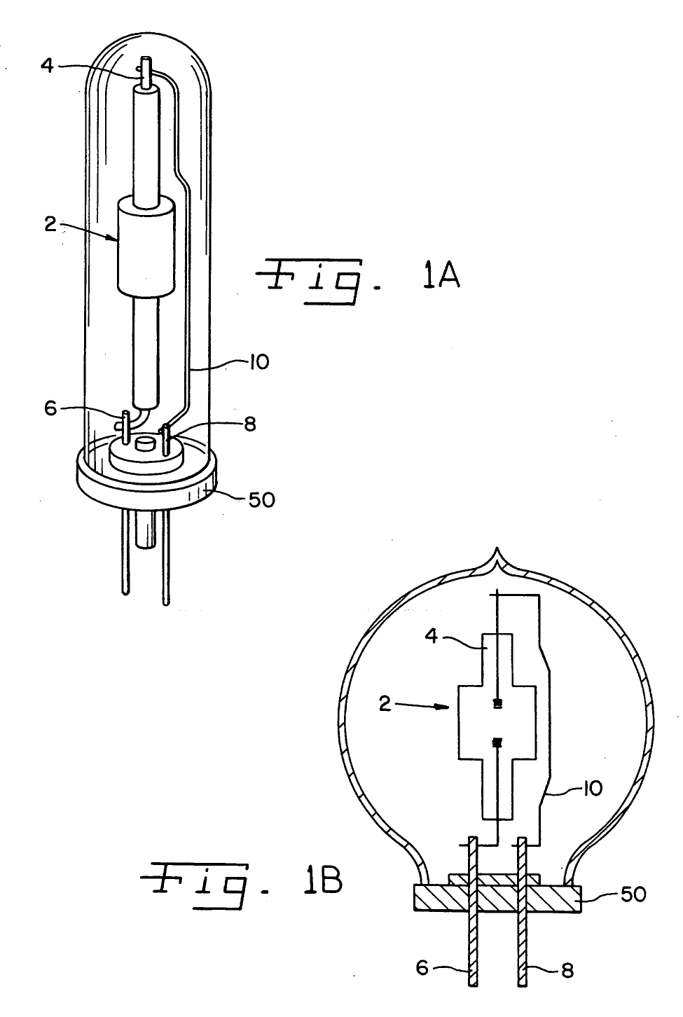

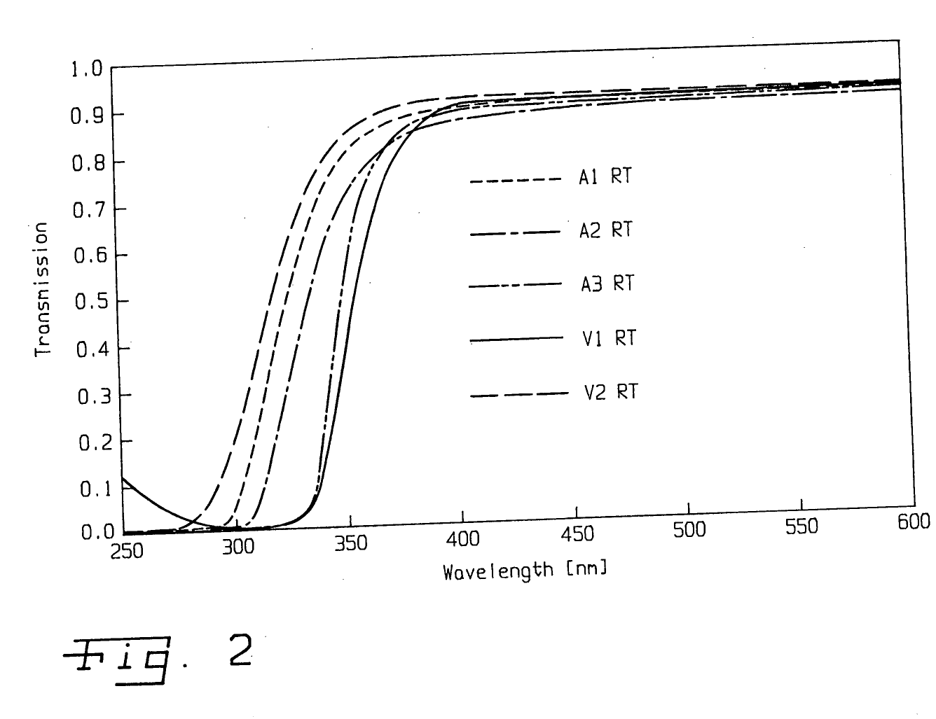

Referring now to the drawings, and more particularly to FIG. 1a, there is shown an HID-lamp, and FIG. 1b is an alternative design, with a leadthrough component as described, for example in WO 2004/077490, incorporated herein by reference.

In addition to the outside bulb 1, FIG. 1a also illustrates the burner system 2 which can be in the form of an Al₂O₃ burner. Burner system 2 is mounted on a nipple 4. The burner system includes a so-called first body which forms the discharge chamber of the burner. Nipple 4 results when the pump stem is flashed off after applying the vacuum that is present in the outside bulb. The so-called earlier fusing point then acts as the top fixed point of the burner system 2 which, in contrast for example to a W-spiral in a halogen lamp possesses clearly a greater mass, so that fastening in the outside bulb is advantageous. In addition, supply wires 6 and outlet wires 8 are shown. The supply wires and outlet wires 6, 8 are rigid enough to hold the burner. However, greater security and reproducibility in the positioning of the burner are achieved, if an extension 10 of the outlet wire 8 is anchored on top of nipple 4.

In accordance with the present invention the outside bulb 1 is formed from an Al-silicate glass. Possible Al-silicate glass compositions are given in the following tables. After outside bulb 1 has been equipped with a burner system, the metal supply wires of the burner are attached.

The metal supply wires are captured in a lead-through component, a so-called base plate 50. Instead of a direct fusing of the outside bulb with a lead-through wire, the outside bulb can be connected by way of a frit ring onto base plate 50 that contains the lead-through wires 68. This reduces the fusing zone to a minimum, as predetermined by thickness of base plate 50.

In order to avoid tensions between the outer bulb and the base plate, as well as in the area of the lead-trough wires the expansion coefficient α_{20/300} of the base plate as well as of the outer bulb is essentially equal to that of the metal of the lead-through wires. The preferred material for the lead-through wires 6, 8 is one of the following metals or alloys: Wolfram/Tungsten, Molybdenum, Niobium metal, Kovar alloy and Molezdenwanov alloy.

According to the thermal expansion coefficient α_{20/300} of these metals the expansion coefficient of the basis plate as well as of the outside bulb is therefore preferably in the inventive range of 3.5≦α_{20/300}≦5.5. For this reason the utilization of quartz glass is generally not possible. Also, the insufficient UV-C blocking advocates a multi-component glass, for example Al-silicate glass.

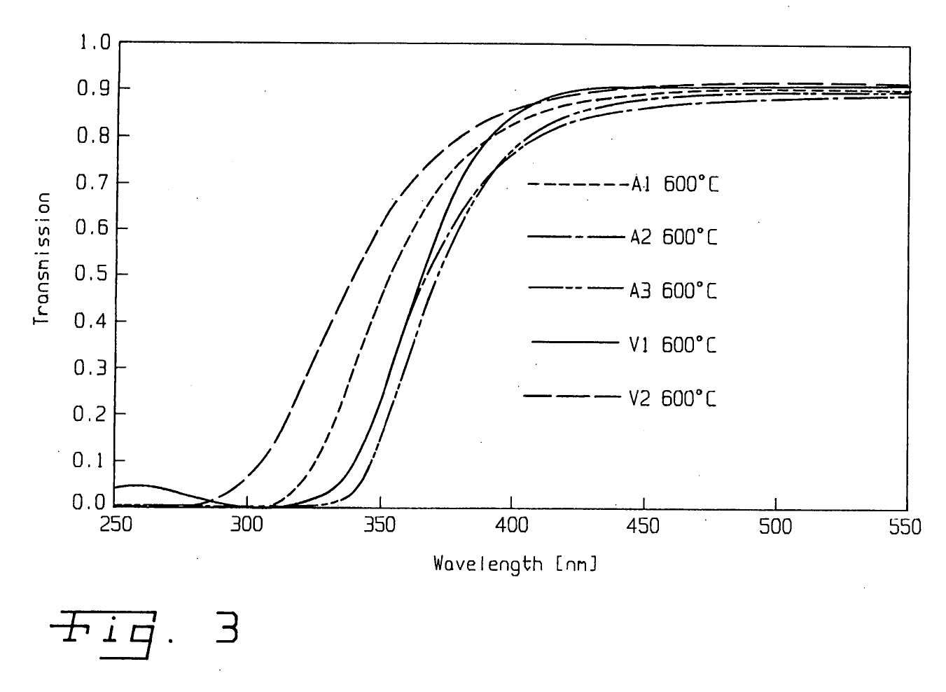

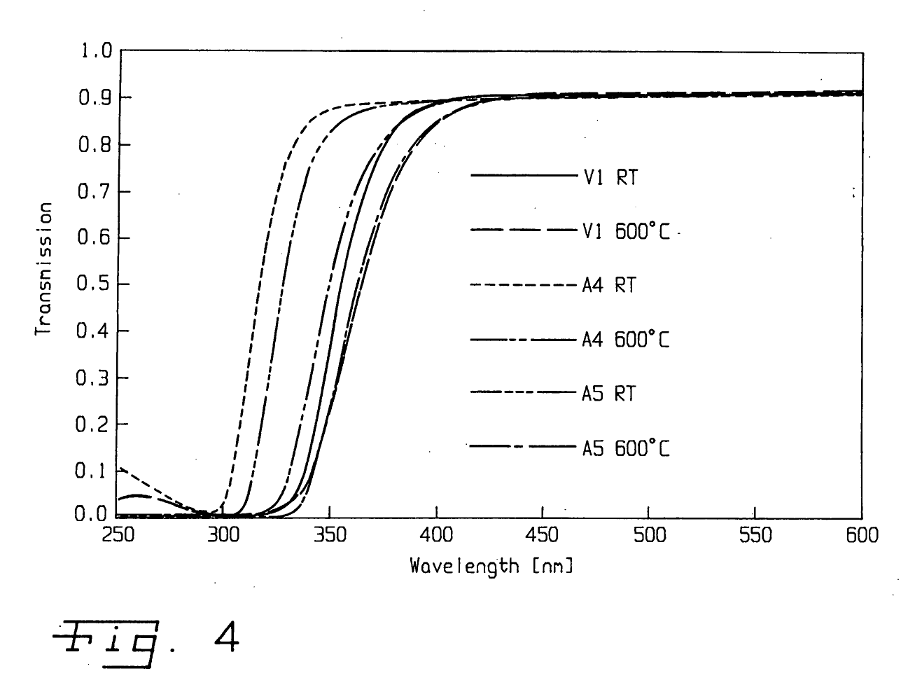

The glasses shown in FIGS. 2 and 3 possess the following compositions and characteristics:

TABLE 1

| | A1 | A2 | A2b | A3 | V1 | V2 |
|---|---|---|---|---|---|---|
| SiO₂ | 59.79 | 58.79 | 58.79 | 59.98 | >=99 | 60.79 |
| Al₂O₃ | 16.52 | 16.52 | 16.52 | 15.62 | | 16.52 |
| B₂O₃ | 0.30 | 0.30 | 0.30 | 0.02 | | 0.30 |
| MgO | | | | 0.70 | | |
| CaO | 13.52 | 13.522 | 13.52 | 9.79 | | 13.52 |
| SrO | | | | 0.21 | | |
| BaO | 7.86 | 7.86 | 7.86 | 13.25 | | 7.86 |
| ZrO₂ | 1.00 | 1.00 | 1.00 | 0.03 | | 1.00 |
| TiO2 | 1.00 | 2.00 | 2.00 | | | |
| CeO₂ | | | | 0.40 | <=1.0 | |
| Fe₂O₃-content | n.b. | 330 ppm | 10 ppm | n.b. | n.b | n.b |
| Sum | 100.0 | 100.0 | 100.0 | 100.0 | 100.0 | 100.0 |
| Alpha 20/300 | 4.73 | 4.76 | n.b. | 4.7 | 0.5 | 4.7 |
| Tg [° C.] | 791 | 783 | n.b. | 790 | ˜1000 | 790 |
| Density [g/cm³] | 2.66 | 2.67 | n.b. | n.b. | ˜2.2 | 2.67 |
| Max. wavelength with | 295 | 305 | 300 | 328 | 324 | 276 |
| Transmission <1% (RT) | | | | | However, transmission | |
| | | | | | still around 260 nm | |
| Max. wavelength with | 314 | 327 | 323 | 334 | 325 | 284 |
| Transmission <1% | | | | | However, transmission | |
| (600° C.) | | | | | Still around 260 nm | |
| Transmission at 400 nm | 89 | 86 | 88 | 88 | 89 | 90 |
| [%] RT | | | | | | |
| Transmission at 600 nm | 84 | 78 | 85 | 79 | 86 | 86 |
| [%] 600° C. | | | | | | |

FIGS. 2 and 3 give the transmission curves for design example A1, design example A2 as well as design example A3, and the comparison examples V1 and V2 at room temperature and 600° C. All examples have a thickness of 1 mm.

V1 is consistent with Ce-doped silica glass which cannot be utilized in the new inventive HID lamp concept, due to lack of adaptation in the expansion coefficient. The UV-edge is advantageous (highest wavelength value where the glass is still transmittive only to max. 1% is: 324 nm), however V1 is still transmittive at 260 nm.

V2 is consistent with a non-UV-blocked Al-silicate glass. Due to the missing UV blocker (the edge position occurs only through the impurities that were introduced by the raw materials) V1 is still transmittive at RT as well as at 600° C. at 290 nm.

The design examples A1, A2 and A2 are comparatively clearly better. At RT the Ti-containing glasses A1 and A2 are no longer transmittive to 295 or 305 nm. The Ce-variation A3 is even optically impervious to 328 nm. At 600° C. glasses A1-A3 are impervious even to max. 310 nm or greater. All inventive variations are impervious at 260 nm against the very damaging UV-C radiation (260 nm).

In contrast to V1, glasses A1, A2 and A3 display a comparative or slightly reduced transmission at 400 nm. As indicated above however, this can be clearly utilized if the emission of the burner unit is excessively blue. The addition of UV blocking substances to Al-silicate glass permits that, at wavelength of 400 nm, in contrast to silica glass, a transmission in the range of 50 to 91% can be variably adjusted. Transmissions of less than 50% cause too heavy a yellow inherent coloring and therefore an excessive filtering effect.

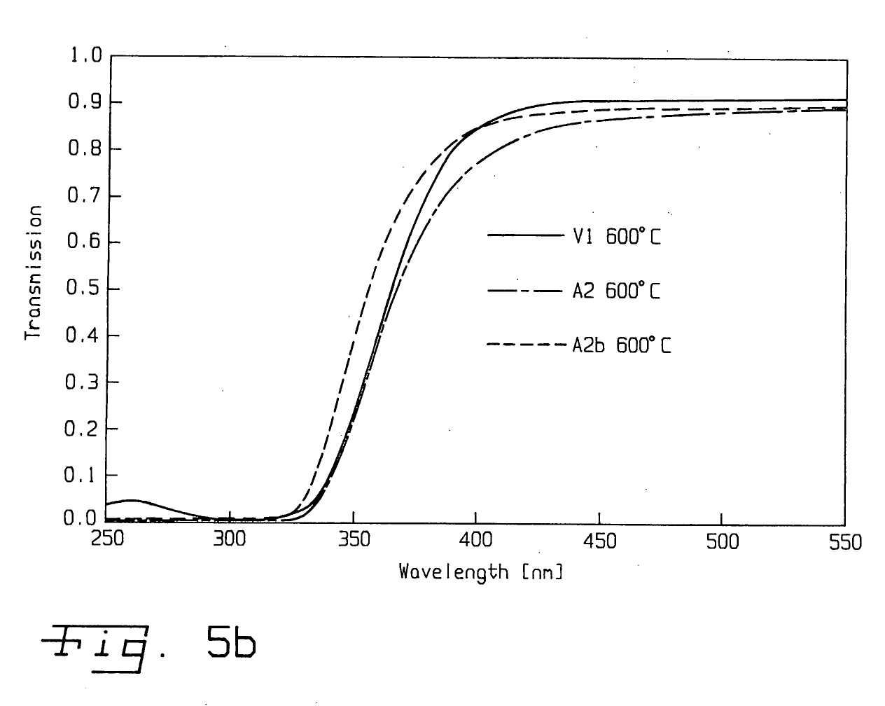

On the other hand a careful selection of raw materials also allows transmissions at 400 nm to be generated more effectively than in the current state of the art (UV-blocked SiO₂). FIGS. 5a and 5b compare the transmission data of glass A2 in FIG. 2 with the data of a glass having the same glass composition A2b. The differences are found in the Fe₂O₃ content (A2: 330 ppm Fe₂O₃, A2b: 10 ppm Fe₂O₃). Accordingly, the edge is steeper at RT as well as 600° C. compare to the Fe-rich variation. There is a greater transmission at 400 nm, however the cut-off or the UV edge have remained approximately the same.

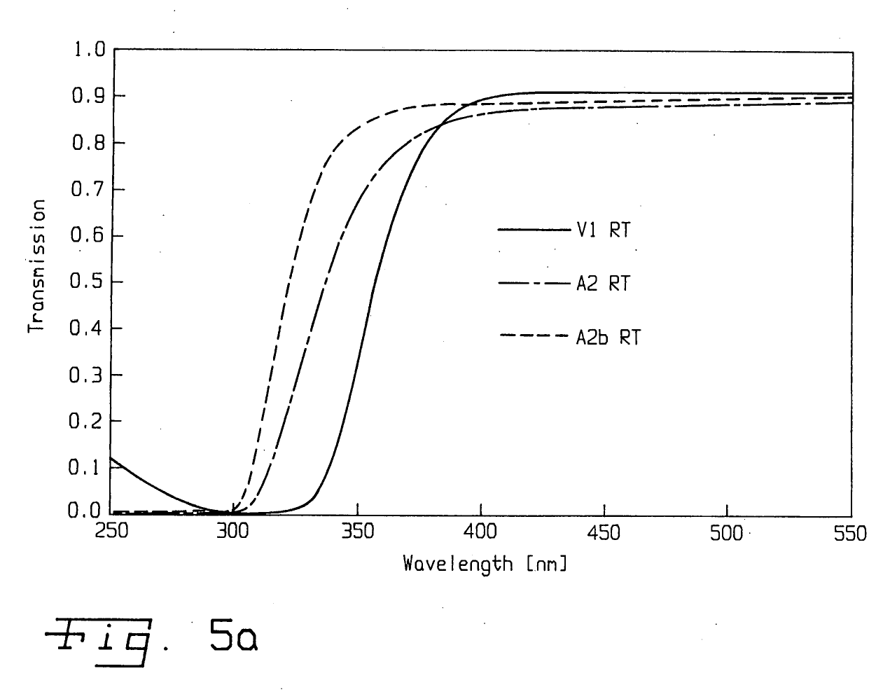

An equally favorable UV edge and thereby transmission curve at room temperature, as well as at 600° C. has been found for the following alkaliferous Al-silicate glasses (in weight % on oxide basis) (design examples A4 and A5; see also FIG. 4). The glass was melted with Fe-deficient raw materials. The Fe₂O₃ content is at around <10 ppm.

TABLE 2
Glass composition for design example A4 in weight %

| | |
|---|---|
| SiO₂ | 65.45 |
| Al₂O₃ | 21.97 |
| Na₂O | 0.51 |
| Li₂O | 3.72 |
| MgO | 0.47 |
| BaO | 2.02 |
| ZnO | 1.70 |
| TiO₂ | 2.39 |
| ZrO₂ | 1.76 |
| Alpha 20/300 | 4.0 ppm/K |
| T_{G} | 690° C. |

TABLE 3
Glass composition for design example A5 in weight %

| | |
|---|---|
| SiO₂ | 64.45 |
| Al₂O₃ | 21.97 |
| Na₂O | 0.51 |
| Li₂O | 3.72 |
| MgO | 0.47 |
| BaO | 2.02 |
| ZnO | 1.70 |
| TiO₂ | 3.4 |
| ZrO₂ | 1.76 |
| Alpha 20/300 | 4.05 ppm/K |
| Tg | 685° C. |

At 600° C. the steepness of the transmission curve in design example A4 is approximately comparative to the transmission curve in design example V1. At 600° C. the transmission curve of A5 is even approximately congruent with V1. When compared with V1, both design examples have the additional great advantage of the complete blockage of the harmful UV-C radiation at 260 nm, as well as that of the thermal expansion that is adapted to the lead-through metals.

Nevertheless, the temperature stability of the compositions according to the design examples 4 and 5 compared with the compositions in accordance with design examples 1 through 3 is reduced. The Tg of 690° C. is however still sufficient for the addressed application.

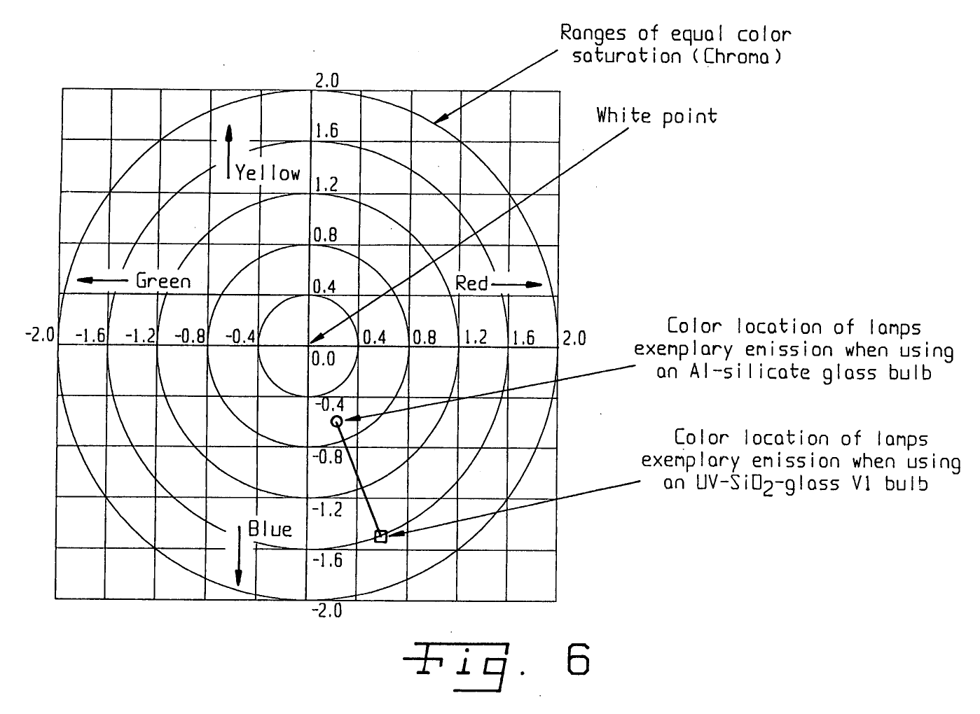

The effect of the transmission of the outside bulb upon the color characteristic of the entire lamp is illustrated in FIG. 6 at an exemplary operating temperature of 600° C. The color of the lamp results from the convolution of the primary emission of the burner with the filter function of the outside bulb.

Differences between the UV-blocked SiO₂ (compare example V1), as well as the design example A3 can be seen in the so-called CIELab color diagram. The design example A3 is advantageous in as far as it moves the coloring further in the direction of the ideal white point. Expressed in values of the CIE system (COMMISSION INTERNATIONALE DE L'ECLAIRAGE; see www.cie.co.at/cie) value C (Chroma, coloring) is reduced by one unit. Advantageously, the CRI (Color Rendering Index) is hardly altered however, the color temperature CCT is advantageously reduced.

All in all, the blue cast of the lamp is reduced due to the yellow-filter effect of the outside bulb material.

TABLE 4
CIE-Color data of lamps with outside bulbs - from
V1 or A3. Data according to CIE Standard 3.13-1955

| | | | Lamp with | | |
|---|---|---|---|---|---|
| | | Lamp with | Al- | Difference | |
| | | UV-SiO₂ | silicate | Lamp | |
| | Exemplary | acc. to | glass | with bulb | |
| | Emission- | V1 | Acc. to A3 | from V1 | |
| | spectrum | (600° C.) | (600° C.) | and A3 | Comments |
| L | 67.4 | 64.9 | 64.71 | −0.1 | Barely |
| | | | | | distin- |
| | | | | | guishable |
| | | | | | decrease |
| | | | | | in the |
| | | | | | luminescence |
| | | | | | (brightness) |
| a | 0.79 | 0.59 | 0.23 | −0.4 | |
| b | −2.03 | −1.51 | −0.61 | 0.9 | |
| C | 2.18 | 1.62 | 0.65 | −1.0 | decrease |
| | | | | | chroma |
| | | | | | (coloring) |
| h | 291 | 291 | 291 | 0.0 | No change |
| | | | | | in the color |
| | | | | | tone |
| CCT | 5610 | 5570 | 5500 | −70.0 | Measurable |
| | | | | | decrease in |
| | | | | | (too high) a |
| | | | | | color |
| | | | | | temperature |
| CRI | 90.8 | 90.7 | 90.6 | −0.1 | Practically |
| | | | | | no effect on |
| | | | | | CRI |

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A light device, comprising:
a first body including a light element;
a second body encompassing said first body, said second body consisting essentially of an Al-silicate glass, said Al-silicate glass having a Tg>600° C. and a thermal expansion coefficient α(20°-300° C.)>0.

2. The light device of claim 1, wherein said light device is a metal halide high pressure discharge lamp.

3. The light device of claim 2, wherein said lamp includes a plate having a current feedthrough and a bulb.

4. The light device of claim 1, wherein said Tg>650° C.

5. The light device of claim 4, wherein said Tg>700° C.

6. The light device of claim 5, wherein said Tg>750° C.

7. The light device of claim 1, wherein said thermal expansion coefficient a (20°-300° C.) is in a range of approximately 3≦α(20°-300° C.)≦6.

8. The light device of claim 7, wherein said thermal expansion coefficient α(20°-300° C.) is in a range of approximately 3.5≦α(20°-300° C.)<5.5.

9. The light device of claim 1, wherein said Al-silicate glass consists essentially of the following composition (weight % on oxide basis):

| | |
|---|---|
| SiO₂ | 50-66 |
| B₂O₃ | 0-5.5 |
| Al₂O₃ | 10-25 |
| MgO | 0-7 |
| CaO | 0-14 |
| SrO | 0-8 |
| BaO | 0-18 |
| P₂O₅ | 0-2 |
| ZeO₂ | 0-3 |
| TiO₂ | 0-5 |
| CeO₂ | 0-5 |
| MoO₃ | 0-5 |
| Fe₂O₃ | 0-5 |
| WO₃ | 0-5 |
| Bi₂O₃ | 0-5. |

10. The light device of claim 1, wherein said Al-silicate glass includes the following components (weight %):

| | |
|---|---|
| SiO₂ | 50-66 |
| B₂O₃ | 0-5.5 |
| Al₂O₃ | 13-25 |
| MgO | 0-7 |
| CaO | 5-14 |
| SrO | 0-8 |
| BaO | 6-18 |
| P₂O₅ | 0-2 |
| ZrO₂ | 0-3 |
| TiO₂ | 0-5 |
| CeO₂ | 0-5 |
| MoO₃ | 0-5 |
| Fe₂O₃ | 0-5 |
| WO₃ | 0-5 |
| Bi₂O₃ | 0-5. |

11. The light device of claim 1, wherein said Al-silicate glass includes the following components (weight %):

| | |
|---|---|
| SiO₂ | 50-66 |
| B₂O₃ | 0-<0.5 |
| Al₂O₃ | 14-25 |
| MgO | 0-7 |
| CaO | 5-14 |
| SrO | 0-8 |
| BaO | 6-18 |
| P₂O₅ | 0-2 |
| ZrO₂ | 0-3. |

12. The light device of claim 1, wherein said Al-silicate glass includes the following components (weight %):

| | |
|---|---|
| SiO₂ | 58-62 |
| B₂O₃ | 0-5.5 |
| Al₂O₃ | 13.5-17.5 |
| MgO | 0-7 |
| CaO | 5.5-14 |
| SrO | 0-8 |
| BaO | 6-10 |
| ZrO₂ | 0-2. |

13. The light device of claim 1, wherein said second body is based on said Al-silicate glass including the following components (weight %):

| | |
|---|---|
| SiO₂ | 50-70 |
| Al₂O₃ | 17-27 |
| Li₂O | 0-5 |
| Na₂O | 0-5 |
| K₂O | 0-5 |
| MgO | 0-5 |
| ZnO | 0-5 |
| TiO₂ | 0-5 |
| ZrO₂ | 0-5 |
| Ta₂O₅ | 0-5 |
| BaO | 0-5 |
| SrO | 0-5 |
| P₂O₅ | 0-5 |
| Fe₂O₃ | 0-5 |
| CeO₂ | 0-5 |
| BiO₃ | 0-5 |
| WO₃ | 0-5 |
| MoO₃ | 0-5. |

and at least one of SnO₂, CeO₂, SO₄, Cl, As₂O₃ Sb₂O₃ in amounts of 0-4 weight % as customary refining agents.

14. The light device of claim 1, wherein said second body is based on said Al-silicate glass including the following components (weight %):

| | |
|---|---|
| SiO₂ | 35-70 |
| Al₂O₃ | 14-40 |
| MgO | 0-20 |
| ZnO | 0-15 |
| TiO₂ | 0-10 |
| ZrO₂ | 0-10 |
| Ta₂O₅ | 0-8 |
| BaO | 0-10 |
| CaO | 0-<8 |
| SrO | 0-5 |
| B₂O₃ | 0-10 |
| P₂O₅ | 0-10 |
| Fe₂O₃ | 0-5 |
| CeO₂ | 0-5 |
| Bi₂O₃ | 0-3 |
| WO₃ | 0-3 |
| MoO₃ | 0-3, |

and at least one of SnO₂, CeO₂, SO₄, Cl, As₂O₃ Sb₂O₃ in amounts of 0-4 weight % as customary refining agents.

15. The light device of claim 14, wherein said second body is based on said Al-silicate glass including the following components (weight %):

| | |
|---|---|
| SiO₂ | 35-60 |
| Al₂O₃ | 16.5-40 |
| MgO | 4-20 |
| ZnO | 0-9 |
| TiO₂ | 1-10 |
| ZrO₂ | 1-10 |
| Ta₂O₅ | 0-2 |
| BaO | 0-8 |
| CaO | 0-5 |
| SrO | 0-4 |
| B₂O₃ | >4-10 |
| P₂O₅ | <4 |
| Fe₂O₃ | 0-5 |
| CeO₂ | 0-5 |
| Bi₂O₃ | 0-3 |
| WO₃ | 0-3 |
| MoO₃ | 0-3, |

and at least one of SnO₂, CeO₂, SO₄, Cl, As₂O₃ Sb₂O₃ in amounts of 0-4 weight % as customary refining agents.

16. The light device of claim 15, wherein said second body is based on said Al-silicate glass including the following components (weight %):

| | |
|---|---|
| SiO₂ | 35-60 |
| Al₂O₃ | 16.5-40 |
| MgO | 6-20 |
| ZnO | 0-4 |
| TiO₂ | 1-10 |
| ZrO₂ | 1-10 |
| Ta₂O₅ | 0-2 |
| BaO | 0-8 |
| CaO | <0.1 |
| SrO | 0-4 |
| B₂O₃ | >4-10 |
| P₂O₅ | <4 |
| Fe₂O₃ | 0-5 |
| CeO₂ | 0-5 |
| Bi₂O₃ | 0-3 |
| WO₃ | 0-3 |
| MoO₃ | 0-3, |

and at least one of SnO₂, CeO₂, SO₄, Cl, As₂O₃ Sb₂O₃ in amounts of 0-4 weight % as customary refining agents.

17. The light device of claim 1, wherein said Al-silicate includes at least one metal oxide selected from the group consisting of TiO₂, CeO₂, Fe₂O₃, WO₃, ZrO₂, MoO₃, Bi₂O_{3, Nb}₂O₅ and/or Ta₂O₅.

18. The light device of claim 17, wherein said at least one metal oxide is approximately in the range of >0 to 8 weight %.

19. The light device of claim 18, wherein said at least one metal oxide is approximately in the range of >0 to 6 weight %.

20. The light device of claim 19, wherein said at least one metal oxide is approximately in the range of >0≦5 weight %.

21. The light device of claim 1, wherein said Al-silicate glass includes at least 0.5% of at least one of TiO₂, CeO₂, Fe₂O₃, WO₃, ZrO₂, MoO₃, Bi₂O₃, Nb₂O₅ and Ta₂O₅.

22. The light device of claim 1, wherein said Al-silicate glass includes Sb₂O₃ and As₂O₃ in an amount of 1 weight % at most.

23. The light device of claim 1, wherein said Al-silicate glass includes at least one of 0-1 weight % Cl and 0-3 weight % SO₃.

24. The light device of claim 1, wherein said Al-silicate glass has an alkaline earth content of approximately 11.6 to 29.0 weight %.

25. The light device of claim 1, wherein said Al-silicate glass includes more than approximately 10 weight % BaO.

26. The light device of claim 1, wherein said Al-silicate glass includes at least approximately 0.5 weight % MgO.

27. The light device of claim 1, wherein said Al-silicate glass includes at least approximately 0.005 weight % CeO₂.

28. The light device of claim 1, wherein said first body consists essentially of one of silica glass and translucent ceramics.

29. The light device of claim 1, wherein said second body is an outside bulb of a metal-halide high pressure discharge lamp.

30. The light device of claim 1, wherein said second body is an explosion shroud of a metal-halide high pressure discharge lamp.

31. The light device of claim 1, wherein said light device includes a metal current supply.

32. The light device of claim 31, wherein said metal current supply includes at least one metal which includes at least one of Wolfram/Tungsten, Molybdenum, Niobium metal, Kovar alloy and Molezdenwanov alloy.

33. The light device of claim 1, further including a leadthrough component that is fastened to said second body and through which a current supply is fed for said light device.

34. The light device of claim 33, wherein said leadthrough component is joined to said second body.

35. The light device of claim 33, wherein said leadthrough component a plate.

36. The light device of claim 33, wherein said leadthrough component includes at least one area through which at least one current supply is fed, said at least one area in a form of a metal component, and said leadthrough component is equipped with a material having a thermal expansion coefficient which essentially corresponds with a thermal expansion coefficient of said metal component at least in an area through which said metal component is fed.

37. The light device of claim 36, wherein said metal component includes at least one material which includes at least one of Wolfram/Tungsten, Molybdenum, Niobium metal, Kovar alloy and Molezdenwanov alloy.

38. The light device of claim 1, wherein said first body is a discharge chamber which is filled with a measurable filler.

39. The light device of claim 38, wherein said measurable filler is at least one discharge medium which includes at least one of mercury, rare earth ions, halides and xenon.

40. The light device of claim 38, wherein said discharge chamber includes a filler gas which is under a pressure of up to approximately 200 bar.

41. The light device of claim 38, wherein said discharge chamber includes a filler gas which is under a pressure of above approximately 200 bar.

42. The light device of claim 1, wherein said Al-silicate glass blocks light in wavelengths of ≦290 nm with a transmission factor <0.01 and in a range of approximately room temperature to 700° C.

43. The light device of claim 1, wherein said Al-silicate glass blocks light in wavelengths of ≦300 nm with a transmission factor <0.01 at a temperature of approximately 600° C.

44. The light device of claim 43, wherein wavelengths are ≦310 nm.

45. The light device of claim 1, wherein said Al-silicate glass has a transmission factor of approximately between 0.5-0.91 at approximately 400 nm.

46. The light device of claim 1, wherein said Al-silicate glass has a transmission factor less than 86% at approximately 400 nm and at approximately 600° C., and a Fe₂O₃ content >10 ppm.

47. The light device of claim 46, wherein said Fe₂O3 content >100 ppm.

48. The light device of claim 46, wherein said Fe₂O₃ content >300 ppm.

49. A method manufacturing a light device using an Al-silicate glass, comprising the step of:
composing said Al-silicate glass consisting essentially of the following (weight % on oxide basis):

| | |
|---|---|
| SiO₂ | 50-66 |
| B₂O₃ | 0-5.5 |
| Al₂O₃ | 10-25 |
| MgO | 0-7 |
| CaO | 0-14 |
| SrO | 0-8 |
| BaO | 0-18 |
| P₂O₅ | 0-2 |
| ZeO₂ | 0-3 |
| TiO₂ | 0-5 |
| CeO₂ | 0-5 |
| MoO₃ | 0-5 |
| Fe₂O₃ | 0-5 |
| WO₃ | 0-5 |
| Bi₂O₃ | 0-5. |

50. The method of claim 49, wherein said light device is a metal halide high pressure discharge lamp.

51. The method of claim 49, wherein said light device includes a first body having a light element; a second body encompassing said first body, said second body including said Al-silicate glass.

52. The method of claim 49, wherein said Al-silicate glass has a Tg>600° C. and a thermal expansion coefficient α(20°-300° C.)>0.

53. The method of claim 52, wherein said Tg>650° C.

54. The method of claim 53, wherein said Tg>700° C.

55. The method of claim 54, wherein said Tg>750° C.

56. The method of claim 52, wherein said thermal expansion coefficient α(20°-300° C.) is in a range of approximately 3≦α(20°-300° C.)<6

57. The method of claim 56, wherein said thermal expansion coefficient a (20°-300° C.) is in a range of approximately 3.5≦α(20°-300° C.)≦5.5.

58. The method of claim 49, wherein said light device includes a plate with a current feedthrough and a bulb.
